(19) United States
(12) Patent Application Publication
(10) Pub. No.: US 2026/0300825 A1
(43) Pub. Date: Oct. 1, 2026

(54) INFORMATION PROCESSING APPARATUS AND INFORMATION PROCESSING METHOD

(71) Applicant: NEC Corporation, Tokyo (JP)

(72) Inventor: Takuya KAWADA, Tokyo (JP)

(73) Assignee: NEC Corporation, Tokyo (JP)

(21) Appl. No.: 19/530,505

(22) Filed: Feb. 5, 2026

(30) Foreign Application Priority Data
Mar. 27, 2025 (JP) 2025-054149

(51) Int. Cl. G06N 20/00; G06F 16/34

(52) U.S. Cl. CPC G06N 20/00; G06F 16/345

(57) ABSTRACT

An information processing apparatus includes at least one memory storing instructions, and at least one processor configured to execute the instructions to acquire an evaluation document in which an evaluation result regarding a difference between target information and first related information is described, a target document in which the target information is described, and a first related document in which the first related information is described, specify a first target description regarding the target information and a first related description regarding the first related information, generate first summary information summarizing the evaluation result, and generate training data as a positive example of one of a search model and an evaluation model and generates training data as a negative example of another. This system thereby supports AI-driven (Artificial Intelligence-driven) decision making by efficiently evaluating differences between target and related information.

### INCORPORATION BY REFERENCE

This application is based upon and claims the benefit of priority from Japanese patent application No. 2025-054149, filed on Mar. 27, 2025, the disclosure of which is incorporated herein in its entirety by reference.

### TECHNICAL FIELD

The present disclosure relates to an information processing apparatus and an information processing method.

### BACKGROUND ART

JP 2021-82177 A describes an information processing apparatus that evaluates whether a reason for refusal in a notification of reasons for refusal can be resolved. The information processing apparatus acquires evaluation data indicating whether a reason for refusal in a notification of reasons for refusal can be resolved by using a machine learning model trained by machine learning using training data including information indicating description in a patent application specification which is a target of the notification of reasons for refusal, information indicating description in a cited document of the notification of reasons for refusal, and information indicating whether a patent decision has been received as a result of a response to the notification of reasons for refusal.

### SUMMARY

Here, not only the notification of reasons for refusal for a patent application but also a difference between desired information (for example, the desired technology or creation) and related information (for example, related technology or related creation) may be desired to be evaluated. Examples of the desired technology include an idea of a technology, a patent application before filing or examination, a paper before posting or before publishing, and the like. Examples of desired creations include a plot for a novel. However, the technique described in JP 2021-82177 A cannot be applied to desired information for which an evaluation result such as a notification of reasons for refusal has not been received.

Therefore, in order to evaluate the difference between the desired information and the related information, it is conceivable to use both a search model for searching for the related information and an evaluation model for evaluating the difference between the desired information and the related information from the viewpoint of an evaluator (for example, an examiner, a reviewer, or the like). However, in order to construct high-quality training data for training such a search model and an evaluation model by machine learning, there is a problem that it takes cost such as manual construction by a human.

The present disclosure has been made in view of the above problems, and an example object of the present disclosure is to provide a technique for reducing cost related to construction of high-quality training data for training a search model and an evaluation model for evaluating a difference between desired information and related information by machine learning.

An information processing apparatus according to an example aspect of the present disclosure includes at least one memory storing instructions, and at least one processor configured to execute the instructions to acquire an evaluation document in which an evaluation result regarding a difference between target information and first related information is described, a target document in which the target information is described, and a first related document in which the first related information is described, specify a first target description indicating a description regarding the target information in the target document and a first related description indicating a description regarding the first related information in the first related document, which are compared in the evaluation result, generate first summary information summarizing the evaluation results, and generate training data as a positive example of one of a search model for searching for related information related to evaluation target information indicated by input information and an evaluation model for evaluating a difference between the evaluation target information and the related information by using a part or all of the first target description, the first related description, and the first summary information, and generating training data as a negative example of another.

An information processing apparatus according to an example aspect of the present disclosure is an information processing apparatus using the search model and the evaluation model trained by machine learning using training data generated by the information processing apparatus described above, comprising at least one memory storing instructions, and at least one processor configured to execute the instructions to acquire input information indicating evaluation target information, search for related information related to the evaluation target information using the search model, and evaluate a difference between the evaluation target information and the related information by using the evaluation model.

An information processing method according to an example aspect of the present disclosure includes document acquisition processing of acquiring, by at least one processor, an evaluation document in which an evaluation result regarding a difference between target information and first related information is described, a target document in which the target information is described, and a first related document in which the first related information is described, first specification processing of specifying, by the at least one processor, a first target description indicating a description regarding the target information in the target document and a first related description indicating a description regarding the first related information in the first related document, which are compared in the evaluation result, first summarizing processing of generating, by the at least one processor, first summary information summarizing the evaluation results, and first training data generation processing of generating, by the at least one processor, training data as a positive example of one of a search model for searching for related information related to evaluation target information indicated by input information and an evaluation model for evaluating a difference between the evaluation target information and the related information by using a part or all of the first target description, the first related description, and the first summary information, and generating training data as a negative example of another.

A program according to an example aspect of the present disclosure is a program for causing a computer to function as an information processing apparatus, the program causing the computer to function as a document acquisition means for acquiring an evaluation document in which an evaluation result regarding a difference between target information and first related information is described, a target document in which the target information is described, and a first related document in which the first related information is described, a first specification means for specifying a first target description indicating a description regarding the target information in the target document and a first related description indicating a description regarding the first related information in the first related document, which are compared in the evaluation result, a first summarizing means for generating first summary information summarizing the evaluation results, and a first training data generation means for generating training data as a positive example of one of a search model for searching for related information related to evaluation target information indicated by input information and an evaluation model for evaluating a difference between the evaluation target information and the related information by using a part or all of the first target description, the first related description, and the first summary information, and generating training data as a negative example of another.

According to an example aspect of the present disclosure, it is possible to provide a technique for reducing a cost related to construction of high-quality training data for training a search model and an evaluation model for evaluating a difference between desired information and related information by machine learning.

### BRIEF DESCRIPTION OF DRAWINGS

The above and other aspects, features, and advantages of the present disclosure will become more apparent from the following description of certain example embodiments in a case where taken in conjunction with the accompanying drawings, in which:

FIG. 1 is a block diagram illustrating a configuration of an information processing apparatus according to the present disclosure;

FIG. 2 is a flowchart illustrating a flow of an information processing method according to the present disclosure;

FIG. 3 is a block diagram illustrating a configuration of an information processing apparatus according to the present disclosure;

FIG. 4 is a flowchart illustrating a flow of an information processing method according to the present disclosure;

FIG. 5 is a block diagram illustrating a configuration of an information processing system according to the present disclosure;

FIG. 6 is a diagram schematically illustrating an example of information generated based on an evaluation document according to the present disclosure;

FIG. 7 is a diagram schematically illustrating an example of information generated based on a target document according to the present disclosure;

FIG. 8 is a flowchart illustrating a flow of an information processing method according to the present disclosure;

FIG. 9 is a flowchart illustrating a detailed flow of steps illustrated in FIG. 8;

FIG. 10 is a flowchart illustrating a detailed flow of steps illustrated in FIG. 8;

FIG. 11 is a diagram schematically illustrating a specific example of training data generated by the information processing method according to the present disclosure;

FIG. 12 is a diagram schematically illustrating training data of a search model generated in a modification according to the present disclosure;

FIG. 13 is a block diagram illustrating a configuration of an information processing system according to the present disclosure;

FIG. 14 is a flowchart illustrating a flow of an information processing method according to the present disclosure;

FIG. 15 is a view schematically illustrating an example of a screen according to the present disclosure; and

FIG. 16 is a block diagram illustrating a hardware configuration of a computer that functions as each apparatus according to the present disclosure.

### EXAMPLE EMBODIMENT

Hereinafter, example embodiments of the present disclosure will be described. However, the present disclosure is not limited to the following exemplary example embodiments, and various modifications can be made within a scope described in the claims. For example, example embodiments obtained by appropriately combining techniques (some or all of things or methods) adopted in the following exemplary example embodiments can also be included in the scope of the present disclosure. Example embodiments obtained by appropriately omitting some of the techniques adopted in the following exemplary example embodiments can also be included in the scope of the present disclosure. Effects mentioned in the following exemplary example embodiments are examples of effects expected in the exemplary example embodiments, and do not define extension of the present disclosure. That is, example embodiments that do not achieve the effects mentioned in the following exemplary example embodiments can also be included in the scope of the present disclosure.

### First Exemplary Example Embodiment

A first exemplary example embodiment that is an example of the example embodiments of the present disclosure will be described in detail with reference to the drawings. The present exemplary example embodiment is a basic form of each exemplary example embodiment to be described below. An application range of each technique adopted in the present exemplary example embodiment is not limited to the present exemplary example embodiment. That is, each technique adopted in the present exemplary example embodiment can also be adopted in another exemplary example embodiment included in the present disclosure within a range in which no particular technical problem occurs. Each technique illustrated in the drawings referred to for describing the present exemplary example embodiment may also be adopted in another exemplary example embodiment included in the present disclosure within a range in which no particular technical problem occurs.

### Configuration of Information Processing Apparatus 1

A configuration of an information processing apparatus 1 will be described with reference to FIG. 1. FIG. 1 is a block diagram illustrating the configuration of the information processing apparatus 1. As illustrated in FIG. 1, the information processing apparatus 1 includes a document acquisition unit 11, a first specification unit 12, a first summarizing unit 13, and a first training data generation unit 14. The document acquisition unit 11 is an example of a configuration that implements a document acquisition means. The first specification unit 12 is an example of a configuration that implements a first specification means. The first summarizing unit 13 is an example of a configuration that implements a first summarizing means. The first training data generation unit 14 is an example of a configuration that implements a first training data generation means.

The document acquisition unit 11 acquires an evaluation document in which an evaluation result regarding a difference between the target information and the first related information is described, a target document in which the target information is described, and a first related document in which the first related information is described. Here, for example, the target information indicates a technique or a creation evaluated by the evaluator. The target information may be, for example, an invention described in a patent application specification, a technique described in a posted paper, a plot for a novel, or the like. The target document indicates a document in which the target information is described. The target document may be, for example, a patent application specification, a paper, a memo describing a plot for a novel, or the like.

The evaluator indicates a person who evaluates the target information. The evaluator may be, for example, an examiner who examines a patent application specification, a reviewer who reviews a paper, an evaluator for a creation, or the like. The evaluation document indicates a document in which an evaluation result regarding the target information is described. For example, the evaluation document may be a notice of reasons for refusal, a decision of refusal, a notice of registration, a written opinion attached to the international search report on the international patent application, a document in which a review result of a paper is described, an evaluation document regarding a creation, or the like.

The first related information is information related to the target information, and indicates information compared with the target information in the evaluation result. The first related information may be, for example, a technique, a creation, or the like described in a cited document cited in a notice of reasons for refusal, a decision of refusal, a notice of registration, a written opinion, a review result, an evaluation document regarding a creation, or the like as described above. The first related document indicates a document in which the first related information is described. The first related document may be the cited document. However, the target information, the target document, the evaluator, the evaluation document, the first related information, and the first related document are not limited to the above-described examples.

The first specification unit 12 specifies a first target description indicating a description regarding the target information in the target document and a first related description indicating a description regarding the first related information in the first related document, which are compared in the evaluation result. For example, the first specification unit 12 may specify the first target description and the first related description using a large language model. As an example, the first specification unit 12 may input, to the large language model, the evaluation result, the target document, the first related document, and an instruction to specify the first target description and the first related description compared in the evaluation result. As a result, the first target description and the first related description output from the large language model are obtained.

For example, the first specification unit 12 may analyze the evaluation document to extract information indicating the description position of the first target description in the target document and the description position of the first related description in the first related document, which are compared in the evaluation result. The description position may be, for example, a paragraph number, a page number, a line number, or a combination thereof, but is not limited thereto. As a result, the first specification unit 12 can specify the first target description and the first related description from the target document and the first related document based on each description position indicated by the extracted information. However, the method for specifying the first target description and the first related description is not limited to the above-described method.

The first summarizing unit 13 generates first summary information summarizing the evaluation results. Here, for example, the first summarizing unit 13 may generate the first summary information using a large language model. As an example, the first summarizing unit 13 may input an evaluation result and an instruction to summarize the evaluation result to the large language model. As a result, the first summary information output from the large language model is obtained. The first summarizing unit 13 is not limited to using a large language model, and may generate the first summary information using a known natural language processing technology capable of generating a summary.

The first training data generation unit 14 generates training data as a positive example of one of the search model and the evaluation model and generates training data as a negative example of another by using a part or all of the first target description, the first related description, and the first summary information. The search model is a model for searching related information related to the evaluation target information indicated by the input information. The evaluation model is a model that evaluates a difference between the evaluation target information and the related information.

Here, the evaluation document may include negative information regarding a difference between the target information and the first related information. The “negative information regarding the difference” may be information indicating that no significant difference is recognized. Examples thereof include a notice of reasons for refusal for a patent application, a decision of refusal, and a document in which a review result of non-acceptance for a paper is described as described above. In this case, there is no significant difference between the target information and the first related information from the viewpoint of the evaluator. In other words, the similarity between the target information and the first related information is high from the viewpoint of the evaluator. Here, as the search model, it is desirable to search related information having a high similarity to the target information. Therefore, it is desirable to train the search model so that the first related description is output in a case where the first target description is input to the search model. Therefore, the first target description and the first related description are training data of a positive example of the search model.

In this case, the first summary information is information indicating that there is no significant difference between the target information and the first related information. Therefore, it is desirable to train the evaluation model so that first summary information indicating that there is no significant difference is output in a case where the first target description and the first related description are input to the evaluation model. Therefore, the first target description, the first related description, and the first summary information are training data of a negative example of the evaluation model.

On the other hand, the evaluation document may include positive information regarding a difference between the target information and the first related information. The “positive information regarding the difference” may be information indicating that there is a significant difference. As an example, a notice of registration issued from the Patent Office of a particular country (for example, U.S., or the like) for a patent application in that country may state a significant difference from the cited document as a reason for registration. In the written opinion or the like attached to the international search report for the international patent application, a significant difference from the cited document may be described as a reason for recognizing novelty and/or inventive step. In this case, there is a significant difference between the target information and the first related information from the viewpoint of the evaluator. In other words, the similarity between the target information and the first related information is low from the viewpoint of the evaluator. Here, it is desirable that related information having a low similarity to the target information is not searched as the search model. Therefore, it is desirable to train the search model so that the first related description is not output even in a case where the first target description is input to the search model. Therefore, the first target description and the first related description are training data of a negative example of the search model.

In this case, the first summary information is information indicating that there is a significant difference between the target information and the first related information. Therefore, it is desirable to train the evaluation model so that first summary information indicating that there is a significant difference is output in a case where the first target description and the first related description are input to the evaluation model. Therefore, the first target description, the first related description, and the first summary information are training data of a positive example of the evaluation model.

### Effects of Information Processing Apparatus 1

As described above, the information processing apparatus 1 includes the document acquisition unit 11 for acquiring an evaluation document in which an evaluation result regarding a difference between target information and first related information is described, a target document in which the target information is described, and a first related document in which the first related information is described, the first specification unit 12 for specifying a first target description indicating a description regarding the target information in the target document and a first related description indicating a description regarding the first related information in the first related document, which are compared in the evaluation result, the first summarizing unit 13 for generating first summary information summarizing the evaluation results, and the first training data generation unit 14 for generating training data as a positive example of one of a search model for searching for related information related to evaluation target information indicated by input information and an evaluation model for evaluating a difference between the evaluation target information and the related information by using a part or all of the first target description, the first related description, and the first summary information, and generating training data as a negative example of another.

Therefore, according to the information processing apparatus 1, the same information obtained based on the evaluation document can be used as training data serving as a positive example of one of the search model and the evaluation model as training data serving as a negative example of another. The training data configured in this manner can be expected to have at least the same quality as training data manually constructed by a human. Therefore, it is possible to obtain an effect of reducing the cost related to construction of high-quality training data for training a search model and an evaluation model for evaluating a difference between desired information and related information by machine learning. It is possible to obtain an effect that the viewpoint of the evaluator can be reflected in the search model and the evaluation model.

### Flow of Information Processing Method S1

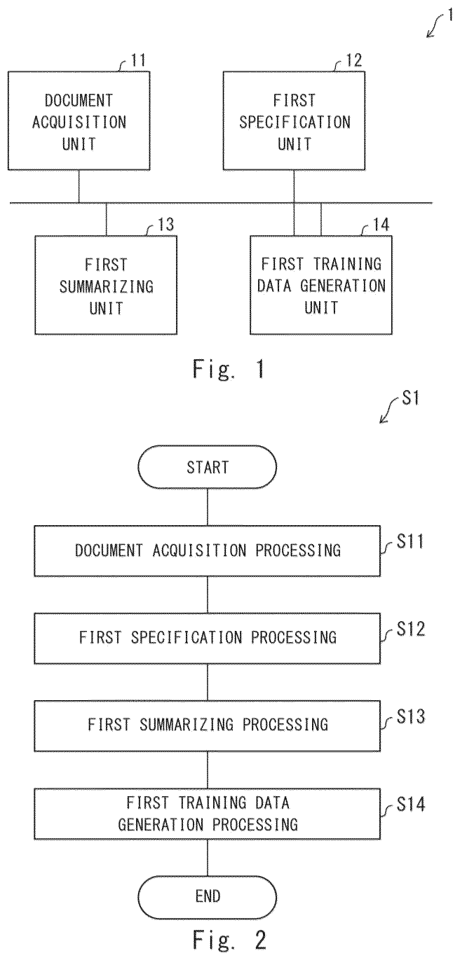

A flow of an information processing method S1 will be described with reference to FIG. 2. FIG. 2 is a flowchart illustrating the flow of the information processing method S1. For example, in a case where the information processing apparatus 1 includes at least one processor, the information processing apparatus 1 executes the information processing method S1. As illustrated in FIG. 2, the information processing method S1 includes document acquisition processing S11, first specification processing S12, first summarizing processing S13, and first training data generation processing S14.

In the document acquisition processing S11, at least one processor (for example, the document acquisition unit 11) acquires the evaluation document in which the evaluation result regarding the difference between the target information and the first related information is described, the target document in which the target information is described, and the first related document in which the first related information is described. Details of the document acquisition processing S11 will be described similarly to the document acquisition unit 11.

In the first specification processing S12, at least one processor (for example, the first specification unit 12) specifies the first target description indicating the description related to the target information in the target document and the first related description indicating the description related to the first related information in the first related document, which are compared in the evaluation result. Details of the first specification processing S12 will be described similarly to the first specification unit 12.

In the first summarizing processing S13, at least one processor (for example, the first summarizing unit 13) generates first summary information summarizing the evaluation results. Details of the first summarizing processing S13 will be described similarly to the first summarizing unit 13.

In the first training data generation processing S14, at least one processor (for example, the first training data generation unit 14) generates training data as a positive example of one of a search model for searching for related information related to evaluation target information indicated by input information and an evaluation model for evaluating a difference between the evaluation target information and the related information by using a part or all of the first target description, the first related description, and the first summary information, and generates training data as a negative example of another. Details of the first training data generation processing S14 will be described similarly to the first training data generation unit 14.

### Effects of Information Processing Method S1

As described above, the information processing method S1 includes document acquisition processing S11 of acquiring, by at least one processor, an evaluation document in which an evaluation result regarding a difference between target information and first related information is described, a target document in which the target information is described, and a first related document in which the first related information is described, first specification processing S12 of specifying, by the at least one processor, a first target description indicating a description regarding the target information in the target document and a first related description indicating a description regarding the first related information in the first related document, which are compared in the evaluation result, first summarizing processing S13 of generating, by the at least one processor, first summary information summarizing the evaluation results, and first training data generation processing S14 of generating, by the at least one processor, training data as a positive example of one of a search model for searching for related information related to evaluation target information indicated by input information and an evaluation model for evaluating a difference between the evaluation target information and the related information by using a part or all of the first target description, the first related description, and the first summary information, and generating training data as a negative example of another. Therefore, according to the information processing method S1, effects similar to those of the information processing apparatus 1 can be obtained.

### Second Exemplary Example Embodiment

A second exemplary example embodiment that is an example of the example embodiments of the present disclosure will be described in detail with reference to the drawings. Components including the same functions as the components described in the above-described exemplary example embodiment are denoted by the same reference signs, and the description thereof will be appropriately omitted. An application range of each technique adopted in the present exemplary example embodiment is not limited to the present exemplary example embodiment. That is, each technique adopted in the present exemplary example embodiment can also be adopted in another exemplary example embodiment included in the present disclosure within a range in which no particular technical problem occurs. Each technique illustrated in each of the drawings referred to for describing the present exemplary example embodiments can be employed in the other exemplary example embodiments included in the present disclosure within the scope in which no particular technical problem occurs.

### Configuration of Information Processing Apparatus 2

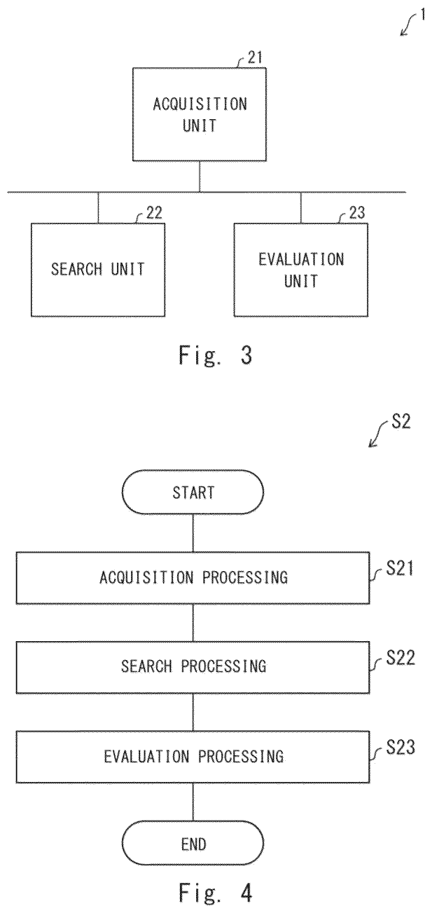

A configuration of an information processing apparatus 2 will be described with reference to FIG. 3. FIG. 3 is a block diagram illustrating a configuration of the information processing apparatus 2. The information processing apparatus 2 is an apparatus using a search model and an evaluation model trained by machine learning using training data generated by the information processing apparatus 1. The information processing apparatus 2 includes an acquisition unit 21, a search unit 22, and an evaluation unit 23. The acquisition unit 21 is an example of a configuration that implements an acquisition means. The search unit 22 is an example of a configuration that implements a search means. The evaluation unit 23 is an example of a configuration that implements an evaluation means.

The acquisition unit 21 acquires input information indicating the evaluation target information. For example, the acquisition unit 21 may acquire input information input by the user.

The search unit 22 searches related information related to the evaluation target information using the above-described search model. The search model is a model trained by machine learning using training data generated by the information processing apparatus 1. Since the training data is generated based on the evaluation document, it can be expected that the viewpoint of the evaluator is reflected in the output of the search model.

The evaluation unit 23 evaluates a difference between the evaluation target information and the related information by using the evaluation model described above. The evaluation model is a model trained by machine learning using training data generated by the information processing apparatus 1. Since the training data is generated based on the evaluation document, it can be expected that the viewpoint of the evaluator is reflected in the output of the evaluation model.

### Effects of Information Processing Apparatus 2

As described above, the information processing apparatus 2 is an information processing apparatus that uses a search model and an evaluation model trained by machine learning using training data generated by the information processing apparatus 1, and employs a configuration including the acquisition unit 21 that acquires input information indicating evaluation target information, the search unit 22 that searches for related information related to the evaluation target information using the search model, and the evaluation unit 23 that evaluates a difference between the evaluation target information and the related information using the evaluation model. As described above, according to the information processing apparatus 2, the search model and the evaluation model trained by machine learning using the training data of the positive example or the negative example generated based on the evaluation document are used. Accordingly, an effect can be obtained in that, for desired information to be evaluated, related information in which a viewpoint of an evaluator is reflected can be searched, and an evaluation result in which the viewpoint of the evaluator is reflected with respect to a difference from the related information can be obtained.

### Flow of Information Processing Method S2

A flow of an information processing method S2 will be described with reference to FIG. 4. FIG. 4 is a flowchart illustrating the flow of the information processing method S2. For example, in a case where the information processing apparatus 2 includes at least one processor, the information processing apparatus 2 executes the information processing method S2. The information processing method S2 is a method using a search model and an evaluation model trained by machine learning using training data generated by the information processing method S1. As illustrated in FIG. 4, the information processing method S2 includes acquisition processing S21, search processing S22, and evaluation processing S23.

In the acquisition processing S21, at least one processor (for example, the acquisition unit 21) acquires input information indicating the evaluation target information. Details of the acquisition processing S21 will be described similarly to the acquisition unit 21.

In the search processing S22, at least one processor (for example, the search unit 22) searches for related information related to the evaluation target information using the search model. Details of the search processing S22 will be described similarly to the search unit 22.

In the evaluation processing S23, at least one processor (for example, the evaluation unit 23) evaluates a difference between the evaluation target information and the related information by using the evaluation model. Details of the evaluation processing S23 will be described similarly to the evaluation unit 23.

### Effects of Information Processing Method S2

As described above, in the information processing method S2, at least one processor includes the acquisition processing S21 of acquiring the input information indicating the evaluation target information, the search processing S22 of searching for the related information related to the evaluation target information using the search model, and the evaluation processing S23 of evaluating the difference between the evaluation target information and the related information using the evaluation model. Therefore, according to the information processing method S2, effects similar to those of the information processing apparatus 2 can be obtained.

### Third Exemplary Example Embodiment

A third exemplary example embodiment that is an example of the example embodiments of the present disclosure will be described in detail with reference to the drawings. Components including the same functions as the components described in the above-described exemplary example embodiment are denoted by the same reference signs, and the description thereof will be appropriately omitted. An application range of each technique adopted in the present exemplary example embodiment is not limited to the present exemplary example embodiment. That is, each technique adopted in the present exemplary example embodiment can also be adopted in another exemplary example embodiment included in the present disclosure within a range in which no particular technical problem occurs. Each technique illustrated in each of the drawings referred to for describing the present exemplary example embodiments can be employed in the other exemplary example embodiments included in the present disclosure within the scope in which no particular technical problem occurs.

### Configuration of Information Processing System 10A

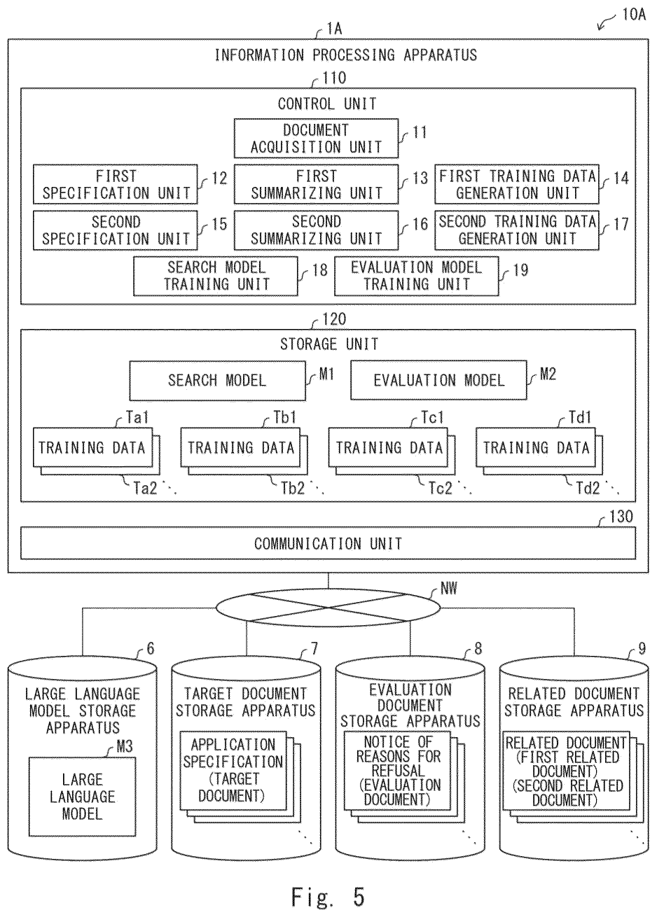

A configuration of an information processing system 10A will be described with reference to FIG. 5. FIG. 5 is a block diagram illustrating a configuration of the information processing system 10A. As illustrated in FIG. 5, the information processing system 10A includes an information processing apparatus 1A, a large language model storage apparatus 6, a target document storage apparatus 7, an evaluation document storage apparatus 8, and a related document storage apparatus 9. The information processing apparatus 1A is communicably connected to each of the large language model storage apparatus 6, the target document storage apparatus 7, the evaluation document storage apparatus 8, and the related document storage apparatus 9 via a network NW. Some or all of these apparatuses may be connected as peripheral devices instead of being connected to the information processing apparatus 1A via the network NW, or may be incorporated in the information processing apparatus 1A. The network NW may include a wireless local area network (LAN), a wired LAN, a wide area network (WAN), a public line network, a mobile data communication network, or some or all of them.

### Large Language Model Storage Apparatus 6

The large language model storage apparatus 6 stores a large language model M3. The large language model M3 is a model capable of executing a natural language processing task such as a question answer task and a summary generation task. The large language model M3 may be a general-purpose model or a model obtained by fine-tuning a general-purpose model using knowledge of a specific field (for example, patent field and the like). For example, in a case where a natural language sentence indicating an execution instruction of the natural language processing task is input, the large language model M3 outputs the result of the natural language processing task as a natural language sentence.

### Target Document Storage Apparatus 7

The target document storage apparatus 7 stores a patent application specification (hereinafter, simply described as the application specification). The application specification is an example of the target document. The invention described in the application specification is an example of the target information. In the application specification (an example of the target document), positive information regarding the difference between the present invention (an example of the target information) and the related art (an example of the second related information) is often included. Related art documents (an example of a second related document) in which the related art mentioned in the application specification is described are described, for example, in items such as “Citation List”. The “positive information regarding the difference” is information indicating that there is a significant difference, and is described in, for example, items such as “Background Art” and “Technical Problem”. In the following, the description will be continued using the application specification including such positive information as an example. The target document storage apparatus 7 desirably stores a plurality of application specifications.

### Evaluation Document Storage Apparatus 8

The evaluation document storage apparatus 8 stores a notice of reasons for refusal. The notice of reasons for refusal includes at least a notice of reasons for refusal issued in response to the patent application indicated by the application specification stored in the target document storage apparatus 7. The notice of reasons for refusal is an example of an evaluation document. The reason for refusal stated in the notice of reasons for refusal is an example of the evaluation result. The examiner who created the notice of reasons for refusal is an example of an evaluator. The notice of reasons for refusal (an example of the evaluation document) contains negative information regarding the difference between the present invention (an example of the target information) and the cited document (an example of the first related information) as reasons for refusal (an example of the evaluation result). The “negative information regarding the difference” is information indicating that no significant difference is recognized, and is, for example, information that denies novelty and/or inventive step. The evaluation document storage apparatus 8 desirably stores a plurality of notices of reasons for refusal. The notice of reasons for refusal stored in the evaluation document storage apparatus 8 and the application specification stored in the target document storage apparatus 7 to which the notice of reasons for refusal has been given are associated with each other.

### Related Document Storage Apparatus 9

The related document storage apparatus 9 stores related documents. The related documents stored include at least the cited documents cited in the notice of reasons for refusal and the related art documents cited in the application specification. Cited documents cited in the notice of reasons for refusal are also referred to as examiner cited documents. The examiner cited document is an example of a first related document. The related art documents cited in the application specification are also referred to as applicant cited documents. The applicant cited document is an example of a second related document. The examiner cited documents and the applicant cited documents may be the same or different. The stored related documents may be divided into constituent units (for example, paragraphs, pages, and the like).

### Information Processing Apparatus 1A

The information processing apparatus 1A includes a control unit 110, a storage unit 120, and a communication unit 130. These units are configured as follows as an example.

### Communication Unit 130

The communication unit 130 is connected to the network NW and communicates with an apparatus outside the information processing apparatus 1A. The communication unit 130 transmits data supplied from the control unit 110 to an external apparatus, and supplies data received from the external apparatus to the control unit 110. As an example, the communication unit 130 communicates with the large language model storage apparatus 6. The data transmitted by the communication unit 130 to the large language model storage apparatus 6 may include input information to the large language model M3. The data received by the communication unit 130 from the large language model storage apparatus 6 may include output information from the large language model M3. As an example, the communication unit 130 communicates with each of the target document storage apparatus 7, the evaluation document storage apparatus 8, and the related document storage apparatus 9. The data transmitted by the communication unit 130 to each of these apparatuses may include a document request. The data received by the communication unit 130 from each of these apparatuses may include the requested document.

### Storage Unit 120

The storage unit 120 stores various data referred to by the control unit 110 and various data generated by the control unit 110. At least a part of the storage unit 120 may be connected to the information processing apparatus 1A as a peripheral device instead of being built in the information processing apparatus 1A, or may be included in an apparatus (not illustrated) communicably connected to the information processing apparatus 1A via the network NW. For example, the storage unit 120 stores the search model M1, the evaluation model M2, the training data Ta1, Ta2, . . . , Tb1, Tb2, . . . , Tc1, Tc2, . . . , Td1, Td2, . . . .

### Search Model M1

The search model M1 is a model for searching for a related technology (an example of related information) related to the technology (an example of evaluation target information) indicated by the input information. For example, input information indicating a desired technology to be evaluated is input to the search model M1. The search model M1 outputs output information including a constituent unit of which similarity to the technology indicated by the input information satisfies a predetermined condition among constituent units of the related documents to be searched. The constituent unit is document description indicating a related technology related to the technology indicated by the input information. The output information may further include information indicating the description position described of the document description. For example, the search model M1 can be configured using a known technique of calculating similarity between documents.

### Evaluation Model M2

The evaluation model M2 is a model that evaluates a difference between a technology to be evaluated (an example of evaluation target information) and a related technology (an example of related information). For example, the evaluation model M2 can be configured by fine-tuning any large language model. For example, in a case where the technology to be evaluated, the related technology, and an instruction to evaluate a difference between these technologies are input, the evaluation model M2 outputs an evaluation result.

### Training Data Ta

The training data Ta1, Ta2, . . . are training data that is a positive example of the search model M1. The positive example of the search model M1 includes input information input to the search model M1 and output information to be output with respect to the input information. In a case where it is not necessary to particularly distinguish and describe each of the training data Ta1, Ta2, . . . , each is also described as the training data Ta. The training data Ta is generated by the first training data generation unit 14 described later. Although two pieces of training data Ta are illustrated in FIG. 5, the number of pieces of generated training data Ta is not limited.

### Training Data Tb

The training data Tb1, Tb2, . . . are training data that is a negative example of the search model M1. The negative example of the search model M1 includes input information input to the search model M1 and output information that may not be output with respect to the input information. In a case where it is not necessary to particularly distinguish and describe each of the training data Tb1, Tb2, . . . , each is also described as the training data Tb. The training data Tb is generated by the second training data generation unit 17 described later. Although two pieces of training data Tb are illustrated in FIG. 5, the number of pieces of generated training data Tb is not limited.

### Training Data Tc

The training data Tc1, Tc2, . . . are training data that is a positive example of the evaluation model M2. The positive example of the evaluation model M2 includes input information input to the evaluation model M2 and output information indicating positive evaluation to be output for the input information. In a case where it is not necessary to particularly distinguish and describe each of the training data Tc1, Tc2, . . . , each is also described as the training data Tc. The training data Tc is generated by the second training data generation unit 17 described later. Although two pieces of training data Tc are illustrated in FIG. 5, the number of pieces of generated training data Tc is not limited.

### Training Data Td

The training data Td1, Td2, . . . are training data that is a negative example of the evaluation model M2. The negative example of the evaluation model M2 includes input information input to the evaluation model M2 and output information indicating negative evaluation to be output for the input information. In a case where it is not necessary to particularly distinguish and describe each of the training data Td1, Td2, . . . , each is also described as the training data Td. The training data Td is generated by the first training data generation unit 14 described later. Although two pieces of training data Td are illustrated in FIG. 5, the number of pieces of generated training data Td is not limited.

### Control Unit 110

The control unit 110 integrally controls each unit of the information processing apparatus 1A. For example, the control unit 110 includes a second specification unit 15, a second summarizing unit 16, a second training data generation unit 17, a search model training unit 18, and an evaluation model training unit 19 in addition to the document acquisition unit 11, the first specification unit 12, the first summarizing unit 13, and the first training data generation unit 14 included in the information processing apparatus 1. The second specification unit 15 is an example of a configuration that implements a second specification means. The second summarizing unit 16 is an example of a configuration that implements a second summarizing means. The second training data generation unit 17 is an example of a configuration that implements a second training data generation means. The search model training unit 18 is an example of a configuration that implements a search model training means. The evaluation model training unit 19 is an example of a configuration that implements an evaluation model training means.

### Document Acquisition Unit 11

The document acquisition unit 11 is configured as follows in addition to being configured similarly to the document acquisition unit 11 included in the information processing apparatus 1. The document acquisition unit 11 further acquires a second related document in which the second related information is described. For example, the document acquisition unit 11 acquires the application specification as the target document from the target document storage apparatus 7. The document acquisition unit 11 acquires a notice of reasons for refusal associated with the application specification as an evaluation document from the evaluation document storage apparatus 8. The document acquisition unit 11 acquires, from the related document storage apparatus 9, the examiner cited document described in the notice of reasons for refusal as the first related document. The document acquisition unit 11 acquires the applicant cited document described in the application specification as the second related document from the related document storage apparatus 9.

### First Specification Unit 12

The first specification unit 12 is configured similarly to the first specification unit 12 included in the information processing apparatus 1. In addition, it is configured as follows. Using the large language model M3, the first specification unit 12 extracts, from the evaluation document, information indicating a description position in the target document of the first target description and a description position in the first related document of the first related description. The first specification unit 12 specifies the first target description and the first related description based on the description position indicated by each piece of extracted information.

Specifically, the first specification unit 12 extracts, from the notice of reasons for refusal, information indicating each of the claim number compared in the reasons for refusal and the description position (for example, a paragraph number, a page number, a line number, and the like) in the examiner cited document using the large language model M3. The “compared claim number” is an example of a “description position in the target document of the first target description”. “Description position in the examiner cited document” is an example of “description position in the first related document of the first related description”.

The first specification unit 12 specifies a description of a claim related to the extracted claim number by extracting the description from the application specification as a first target description. The first specification unit 12 specifies a description related to the extracted description position by extracting the description from the examiner cited document as the first related description.

The notice of reasons for refusal may include a plurality of reasons for refusal. The notice of reasons for refusal may include a plurality of pairs (hereinafter, described as a comparison pair) of “compared claim number” and “description position in the examiner cited document”. The first specification unit 12 performs processing of specifying the first target description and the first related description for each comparison pair of reasons for refusal.

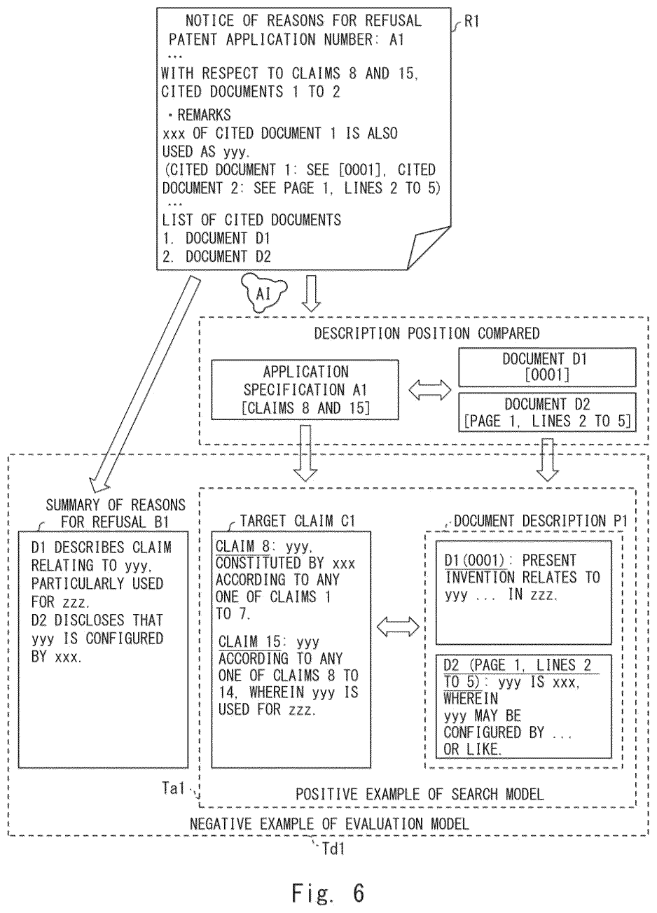

An example of the first target description and the first related description will be described with reference to FIG. 6. FIG. 6 is a diagram schematically illustrating an example of information generated based on the evaluation document. In FIG. 6, the notice of reasons for refusal R1 is a document notified to the patent application indicated by the application specification A1. For example, the first specification unit 12 inputs an instruction “extract claim number compared in notice of reasons for refusal R1 and description position in examiner cited document” and the notice of reasons for refusal R1 to the large language model M3. The figure including the character string “AI” and the arrows illustrated in the vicinity of the figure illustrated in FIG. 6 schematically indicate that processing is performed by an artificial intelligence (AI) technology using the large language model M3. It similarly applies to other drawings referred to below. As a result, from the large language model M3, “claims 8 and 15” as the claim number, and the description position of examiner cited document D1 “paragraph number [0001]” and the description position of examiner cited document D2 “page 1, lines 2 to 5” contrasted with claims 8 and 15 are output.

Next, the first specification unit 12 extracts the description of claim 8 and the description of claim 15 from the application specification A1, and sets the extracted descriptions of these claims as the target claim C1. Target claim C1 is an example of the first target description. As described above, by extracting the description itself as it is rather than the summary of the description of the claim related to the claim number as the first target description, in a case where the search model M1 and the evaluation model M2 after training are used, it is possible to accurately deal with the input information described in the form of claims in the application specification (hereinafter, also referred to as claim form). The first specification unit 12 extracts the description of paragraph [0001] from the examiner cited document D1 and extracts the description of page 1, lines 2 to 5 from the examiner cited document D2, and sets the descriptions extracted from the examiner cited documents D1 and D2 as document description P1. Document description P1 is an example of a first related description.

### First Summarizing Unit 13

The first summarizing unit 13 is configured as follows in addition to being configured similarly to the first summarizing unit 13 included in the information processing apparatus 1. The first summarizing unit 13 generates first summary information summarizing the reasons for refusal described in the notice of reasons for refusal using the large language model M3.

An example of the first summary information will be described with reference to FIG. 6. As shown in FIG. 6, the first summarizing unit 13 inputs, to the large language model M3, an instruction to summarize the reasons for refusal described for the relevant comparison pair in the notice of reasons for refusal R1 and the notice of reasons for refusal R1. As a result, the summary of reasons for refusal B1 is output from the large language model M3.

### First Training Data Generation Unit 14

The first training data generation unit 14 is configured as follows in addition to being configured similarly to the first training data generation unit 14 included in the information processing apparatus 1. The first training data generation unit 14 generates the training data Ta as a positive example of the search model M1 using the first target description and the first related description. The first training data generation unit 14 generates training data Td that is a negative example of the evaluation model by using the first target description, the first related description, and the first summary information.

An example of the training data will be described with reference to FIG. 6. As shown in FIG. 6, the target claim C1 (an example of the first target description) and the document description P1 (an example of the first related description) have no significant difference from the viewpoint of the examiner, in other words, have high similarity. Therefore, it is desirable to train the search model M1 so as to output the document description P1 in a case where the target claim C1 is input. Therefore, information in which the target claim C1 and the document description P1 are associated with each other is stored in the storage unit 120 as the training data Ta1 that is a positive example of the search model M1.

The summary of reasons for refusal B1 (an example of the first summary information) is information indicating that there is no significant difference between the target claim C1 (an example of the first target description) and the document description P1 (an example of the first related description). Therefore, it is desirable to train the evaluation model M2 so as to output the summary of reasons for refusal B1 in a case where the target claim C1 and the document description P1 are input. Therefore, as training data Td1 that is a negative example of the evaluation model M2, information in which the target claim C1, the document description P1, and the summary of reasons for refusal B1 are associated with each other is stored in the storage unit 120.

### Second Specification Unit 15

The second specification unit 15 specifies the second target description indicating the description related to the target information in the target document and the second related description indicating the description related to the second related information in the second related document, which are compared in the above-described positive information included in the target document. For example, the second specification unit 15 may extract, from the target document, information indicating the description position in the target document of the second target description and the description position in the second related document of the second related description, using the large language model M3. The second specification unit 15 may specify the second target description and the second related description based on the description position indicated by each piece of extracted information.

Specifically, using the large language model M3, the second specification unit 15 extracts, from the application specification, information indicating each of the claim number and the description position in the applicant cited document compared in the description regarding a significant difference from the related art (an example of positive information). The “compared claim number” is an example of a “description position in the target document of the second target description”. “Description position in the applicant cited document” is an example of “description position in the second related document of the second related description”. The “description regarding a significant difference from the related art” in the application specification may not include information indicating a claim number or information indicating a description position in the applicant cited document. In this case, it is possible to instruct the large language model M3 to extract the “compared claim number” based on the “description related to the present invention” and the “Claims” included in the description indicating the significant difference. Similarly, it is possible to instruct the large language model M3 to extract the “description position in the applicant cited document being compared” based on the “description related to the related art” and the “applicant cited document” included in the description indicating the significant difference.

The second specification unit 15 specifies a description of a claim related to the extracted claim number by extracting the description from the application specification as a second target description. The second specification unit 15 specifies the description related to the extracted description position by extracting the description from the applicant cited document as the second related description.

In the application specification, there is a possibility that a plurality of comparison pairs of “compared claim number” and “description position in applicant cited document” are described. The second specification unit 15 performs processing of specifying the second target description and the second related description for each comparison pair.

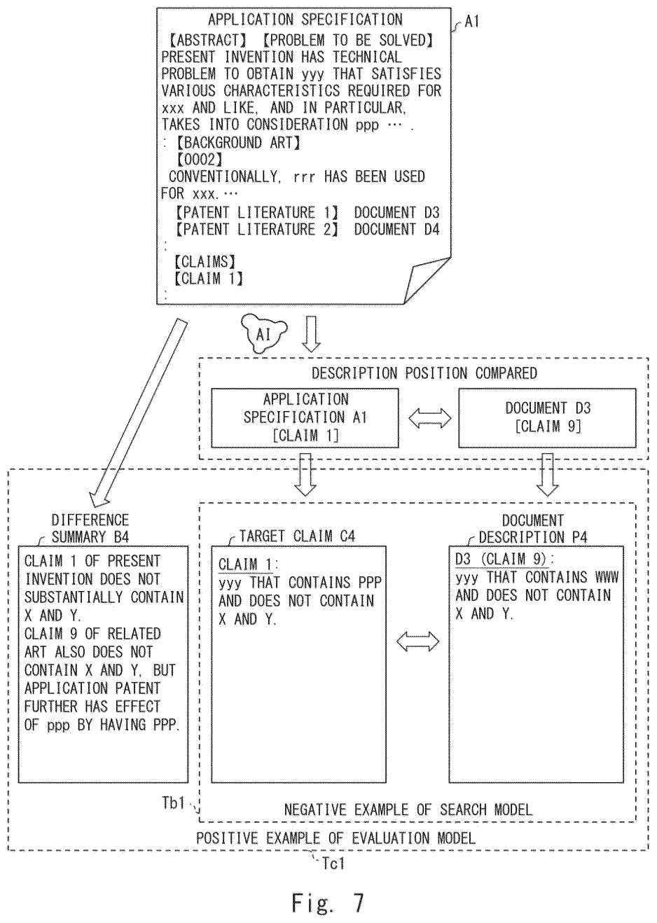

An example of the second target description and the second related description will be described with reference to FIG. 7. FIG. 7 is a diagram schematically illustrating an example of information generated based on the target document. In FIG. 7, the application specification A1 is a document showing a patent application that is the target of the notice of reasons for refusal R1. For example, the second specification unit 15 inputs an instruction “extract claim number compared in application specification A1 and description position in applicant cited document” and the application specification A1 to the large language model M3. Instead of inputting the entire application specification A1 to the large language model M3, a partial description that may include a description regarding a significant difference in the application specification A1 may be input. Parts of the application specification that may include descriptions relating to significant differences include, but are not limited to, items such as “Background Art”, “Citation List”, “Technical Problem”, “Solution to Problem”, “Advantageous Effects of Invention”, and “Claims”. As a result, “claim 1” and the description position “claim 9” of the applicant cited document D3 compared with claim 1 are output as claim numbers from the large language model M3.

Next, the second specification unit 15 extracts the description of claim 1 from the application specification A1, and sets the extracted description of claim 1 as a target claim C4. Target claim C4 is an example of the second target description. In this manner, by extracting not the summary of the description of the claim related to the claim number but the description itself as it is as the second target description, it is possible to accurately deal with the input information described in the claim form in a case where the search model M1 and the evaluation model M2 after training are used. The second specification unit 15 extracts the description of claim 9 from the applicant cited document D3, and sets the extracted description of claim 9 as document description P4. Document description P4 is an example of the second related description.

### Second Summarizing Unit 16

The second summarizing unit 16 generates second summary information summarizing the positive information described above included in the target document. For example, the second summarizing unit 16 may generate second summary information summarizing “information regarding significant differences from the related art” described in the application specification using the large language model M3.

An example of the second summary information will be described with reference to FIG. 7. As illustrated in FIG. 7, the second summarizing unit 16 inputs, to the large language model M3, an instruction to summarize information regarding significant differences described for relevant comparison pairs in the application specification A1, and the application specification A1. Instead of inputting the entire application specification A1 to the large language model M3, a partial description that may include a description regarding a significant difference in the application specification A1 may be input. An example of a portion that may include a description regarding a significant difference in the application specification is as described above. As a result, the difference summary B4 is output from the large language model M3.

### Second Training Data Generation Unit 17

The second training data generation unit 17 generates training data as a positive example of one of the search model M1 and the evaluation model M2 and generates training data as a negative example of another by using a part or all of the second target description, the second related description, and the second summary information. For example, the second training data generation unit 17 generates the training data Tb as a negative example of the search model M1 using the second target description and the second related description. The second training data generation unit 17 generates training data Tc as a positive example of the evaluation model M2 by using the second target description, the second related description, and the second summary information.

An example of the training data will be described with reference to FIG. 7. As shown in FIG. 7, the target claim C4 (an example of the second target description) and the document description P4 (an example of the second related description) have significant differences from the viewpoint of the applicant, in other words, have low similarity. Therefore, it is desirable to train the search model M1 so that the document description P4 is not output in a case where the target claim C4 is input. Therefore, information in which the target claim C4 and the document description P4 are associated with each other is stored in the storage unit 120 as the training data Tb1 that is a negative example of the search model M1.

Difference summary B4 (an example of the second summary information) is information indicating that there is a significant difference between target claim C4 (an example of the second target description) and document description P4 (an example of the second related description). Therefore, it is desirable to train the evaluation model M2 so as to output the difference summary B4 in a case where the target claim C4 and the document description P4 are input. Therefore, information in which the target claim C4, the document description P4, and the difference summary B4 are associated with each other is stored in the storage unit 120 as the training data Tc1 which is a positive example of the evaluation model M2.

### Search Model Training Unit 18

The search model training unit 18 trains the search model M1 by machine learning using the training data Ta and Tb generated as a positive example or a negative example of the search model M1. For example, the search model training unit 18 may adjust the parameter of the feature amount space used by the search model M1 so that the similarity between the target claim and the document description included in the training data Ta as a positive example becomes higher. For example, the search model training unit 18 may adjust the parameter of the feature amount space used by the search model M1 so that the similarity between the target claim and the document description included in the training data Tb as a negative example becomes lower.

### Evaluation Model Training Unit 19

The evaluation model training unit 19 trains the evaluation model M2 by machine learning using the training data Tc and Td generated as a positive example or a negative example of the evaluation model M2. For example, the evaluation model training unit 19 may train the evaluation model M2 so that a summary of reasons for refusal is output in a case where target claims and document descriptions included in the training data Tc are input. For example, the evaluation model training unit 19 may train the evaluation model M2 so that a difference summary is output in a case where the target claims and document descriptions included in the training data Td are input.

### Flow of Information Processing Method S1A

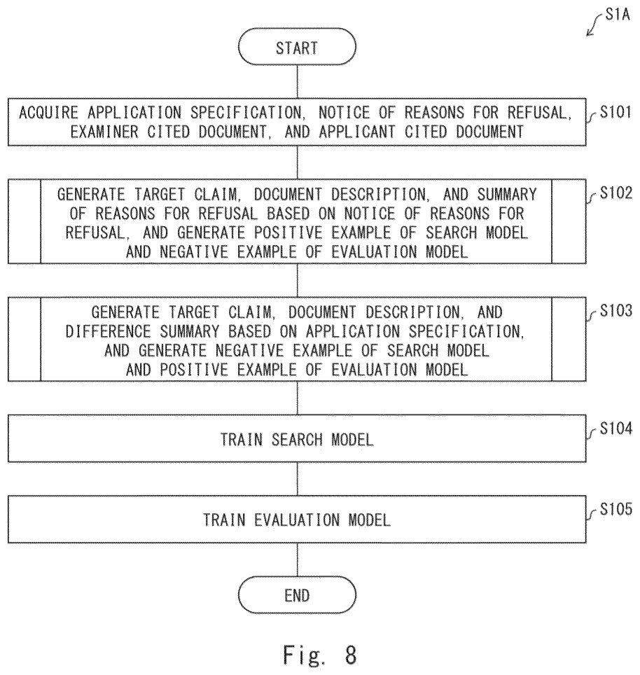

The information processing apparatus 1A configured as described above executes an information processing method S1A. FIG. 8 is a flowchart illustrating a flow of the information processing method S1A. As illustrated in FIG. 8, the information processing method S1A includes steps S101 to S105.

Step S101 is an example of document acquisition processing. In step S101, the document acquisition unit 11 acquires the application specification from the target document storage apparatus 7. The document acquisition unit 11 acquires the notice of reasons for refusal notified to the application specification from the evaluation document storage apparatus 8. The document acquisition unit 11 acquires, from the related document storage apparatus 9, the examiner cited documents cited in the notice of reasons for refusal and the applicant cited documents cited in the application specification.

In step S102, based on the notice of reasons for refusal, the control unit 110 generates target claims and document descriptions to be compared and a summary of reasons for refusal. The control unit 110 generates the training data Ta as a positive example of the search model M1 and the training data Td as a negative example of the evaluation model M2 by using a part or all of the target claim, the document description, and the summary of reasons for refusal.

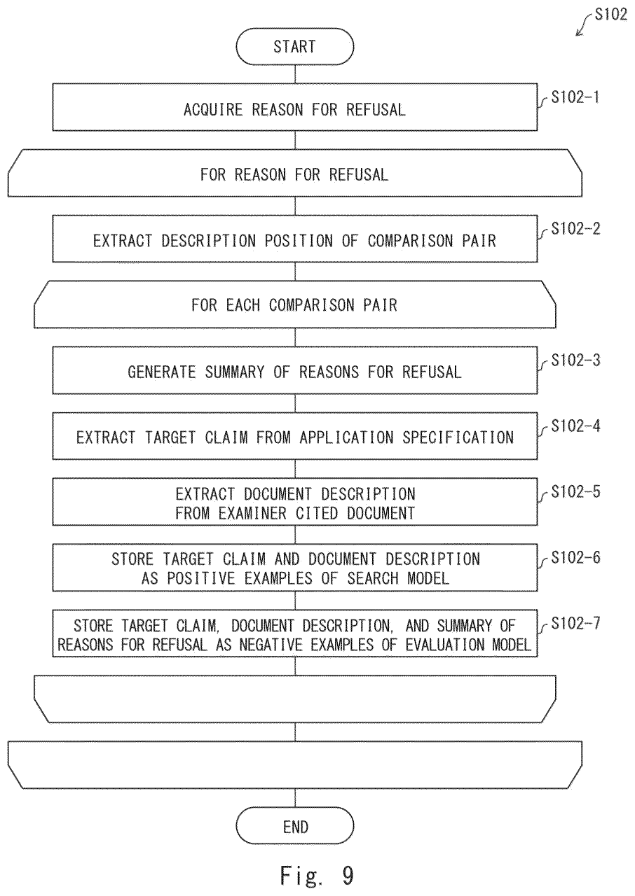

FIG. 9 is a flowchart illustrating a detailed flow of step S102. As illustrated in FIG. 9, step S102 includes steps S102-1 to S102-7.

In step S102-1, the control unit 110 extracts one or each of a plurality of reasons for refusal from the notice of reasons for refusal. For example, a reason for refusal regarding novelty and a reason for refusal regarding inventive step may be extracted. Other reasons for refusal, such as incomplete description, which are not related to the difference from the cited documents, may be excluded from the scope of processing. The large language model M3 may be used for the extraction. The control unit 110 executes steps S102-2 to S102-7 for each reason for refusal extracted.

In step S102-2, the first specification unit 12 extracts one or a plurality of comparison pairs to be compared in the reason for refusal. Each comparison pair includes information regarding claim numbers and description positions in the examiner cited documents. The control unit 110 executes steps S102-3 to S102-7 for each extracted comparison pair.

Step S102-3 is an example of the first summarizing processing. In step S102-3, the first summarizing unit 13 uses the large language model M3 to generate a summary of reasons for refusal (an example of first summary information) summarizing the reasons for refusal regarding the comparison pair.

Steps S102-4 to S102-5 are an example of the first specification processing. In step S102-4, the first specification unit 12 extracts the description of the target claim indicated by the claim number included in the comparison pair (an example of the first target description) from the application specification.

In step S102-5, the first specification unit 12 extracts the document description (an example of the first related description) indicated by the description position in the examiner cited document included in the comparison pair from the examiner cited document.

Steps S102-6 to S102-7 are an example of first training data generation processing. In step S102-6, the first training data generation unit 14 stores the target claim and the document description in the storage unit 120 as training data Ta that is a positive example of the search model M1.

In step S102-7, the first training data generation unit 14 stores the target claim, the document description, and the summary of reasons for refusal in the storage unit 120 as training data Td that is a negative example of the evaluation model M2.

This is the end of the detailed description of the flow in step S102.

In step S103 of FIG. 8, the control unit 110 generates the compared target claims and document descriptions and the difference summary based on the application specification. The control unit 110 generates the training data Tb as a negative example of the search model M1 and the training data Tc as a positive example of the evaluation model M2 by using a part or all of the target claims, the document description, and the difference summary.

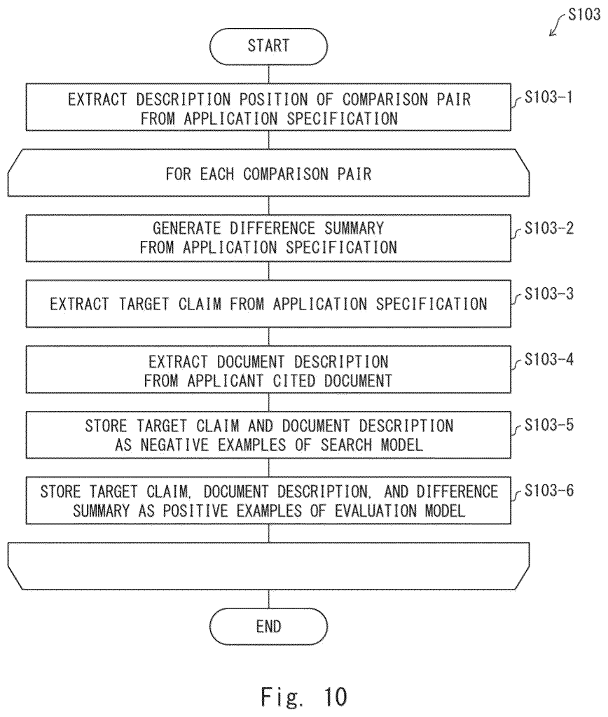

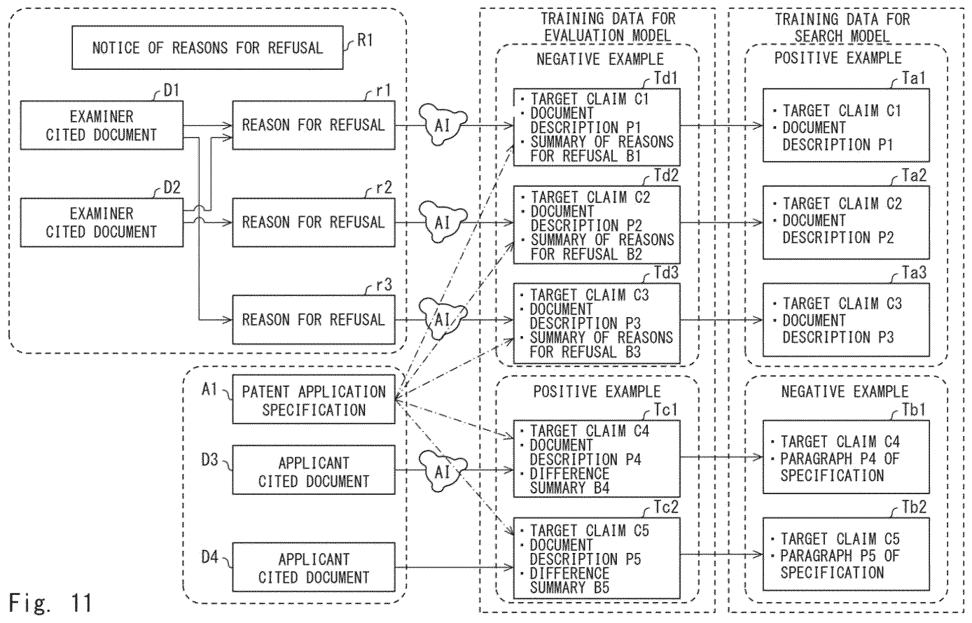

FIG. 10 is a flowchart illustrating a detailed flow of step S103. As illustrated in FIG. 10, step S103 includes steps S103-1 to S103-6.

In step S103-1, the control unit 110 extracts one or a plurality of comparison pairs being compared in the information regarding the significant difference described in the application specification. Each comparison pair includes claim numbers and information indicating the description positions in the applicant cited documents. The control unit 110 executes steps S103-2 to S103-6 for each extracted comparison pair.

Step S103-2 is an example of the second summarizing processing. In step S103-2, the second summarizing unit 16 uses the large language model M3 to generate a difference summary (an example of second summary information) summarizing information regarding significant differences regarding the comparison pair.

Steps S103-3 to S103-4 are an example of the second specification processing. In step S103-3, the second specification unit 15 extracts the description of the target claim indicated by the claim number included in the comparison pair (an example of the second target description) from the application specification.

In step S103-4, the second specification unit 15 extracts the document description (an example of the second related description) indicated by the description position in the applicant cited documents included in the comparison pair from the applicant cited documents.

Steps S103-5 to S103-6 are an example of the second training data generation processing. In step S103-5, the second training data generation unit 17 stores the target claim and the document description in the storage unit 120 as training data Tb that is a negative example of the search model M1.

In step S103-6, the second training data generation unit 17 stores the target claim, the document description, and the difference summary in the storage unit 120 as training data Tc that is a positive example of the evaluation model M2.

This is the end of the detailed description of the flow in step S103.

Step S104 in FIG. 8 is an example of the search model training processing. In step S104, the search model training unit 18 trains the search model M1 using the training data Ta and Tb.

Step S105 is an example of the evaluation model training processing. In step S105, the evaluation model training unit 19 trains the evaluation model M2 using the training data Tc and Td.

Thus, the Information Processing Method S1a Ends.

### Specific Example

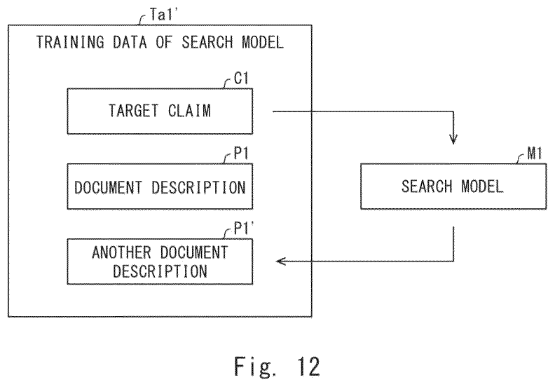

FIG. 11 is a diagram schematically illustrating a specific example of training data generated by the information processing method S1A. As shown in FIG. 11, in the notice of reasons for refusal R1, the examiner cited documents D1 and D2 are cited. The notice of reasons for refusal R1 includes reasons for refusal r1, r2, and r3.

From the reason for refusal r1, as a comparison pair, the target claim C1 included in the application specification A1 and the document description P1 included in the examiner cited documents D1 and D2 are identified. The summary of reasons for refusal B1 summarizing the reason for refusal r1 has been generated. The target claim C1 and the document description P1 constitute training data Ta1 that is a positive example of the search model M1. The target claim C1, the document description P1, and the summary of reasons for refusal B1 constitute training data Td1 that is a negative example of the evaluation model M2.

Similarly, from the reason for refusal r2, the target claim C2 included in the application specification A1 and the document description P2 included in the examiner cited document D2 are identified as a comparison pair. The summary of reasons for refusal B2 summarizing the reason for refusal r2 has been generated. The target claim C2 and the document description P2 constitute training data Ta2 that is a positive example of the search model M1. The target claim C2, the document description P2, and the summary of reasons for refusal B2 constitute training data Td2 that is a negative example of the evaluation model M2.

Similarly, from the reason for refusal r3, the target claim C3 included in the application specification A1 and the document description P3 included in the examiner cited document D1 are identified as a comparison pair. The summary of reasons for refusal B3 summarizing the reason for refusal r3 has been generated. The target claim C3 and the document description P3 constitute training data Ta3 that is a positive example of the search model M1. The target claim C3, the document description P3, and the summary of reasons for refusal B3 constitute training data Td3 that is a negative example of the evaluation model M2.

As illustrated in FIG. 11, applicant cited documents D3 and D4 are cited in application specification A1. It is assumed that, from the application specification A1, the target claim C4 included in the application specification A1 and the document description P4 included in the applicant cited document D3 are specified as a comparison pair. It is assumed that a difference summary B4 is generated based on the application specification A1. Difference summary B4 is information summarizing information regarding significant differences regarding the comparison pair described in application specification A1. The target claim C4 and the document description P4 constitute training data Tb1 that is a negative example of the search model M1. The target claim C4, the document description P4, and the difference summary B4 constitute training data Tc1 that is a positive example of the evaluation model M2.

Similarly, from the application specification A1, the target claim C5 included in the application specification A1 and the document description P5 included in the applicant cited document D4 are specified as a comparison pair. It is assumed that a difference summary B5 is generated based on the application specification A1. Difference summary B5 is information summarizing information regarding significant differences regarding the comparison pair described in application specification A1. The target claim C5 and the document description P5 constitute training data Tb2 that is a negative example of the search model M1. The target claim C5, the document description P5, and the difference summary B5 constitute training data Tc2 that is a positive example of the evaluation model M2.

In this manner, training data Ta1 to Ta3 and Tb1 to Tb2 as positive examples and negative examples of the search model M1 and training data Tc1 to Tc2 and Td1 to Td3 as positive examples and negative examples of the evaluation model M2 are generated from the application specification A1 and the notice of reasons for refusal R1. Therefore, the construction cost of the training data can be reduced as compared with a case where the training data of the search model M1 and the evaluation model M2 is separately generated.

### Modified Example

As training data of the search model M1, output information as a positive example and output information as a negative example may be required for the same input information. In such a case, the first training data generation unit 14 may generate the training data of the search model M1 as follows.

As a third related description that is a negative example with respect to the first target description, the first training data generation unit 14 may further generate at least a part of information different from the first related description among the information included in the first related document, or output information obtained by inputting the first target description to the search model M1 before training. In this case, the first training data generation unit 14 may further include a third related description as a negative example in the training data Ta as a positive example of the search model M1.

Here, “at least a part of the information different from the first related description among the information included in the first related document” may be, for example, information included in a description position different from a description position in which a contrasting related technology is described in the examiner cited document which is the first related document.

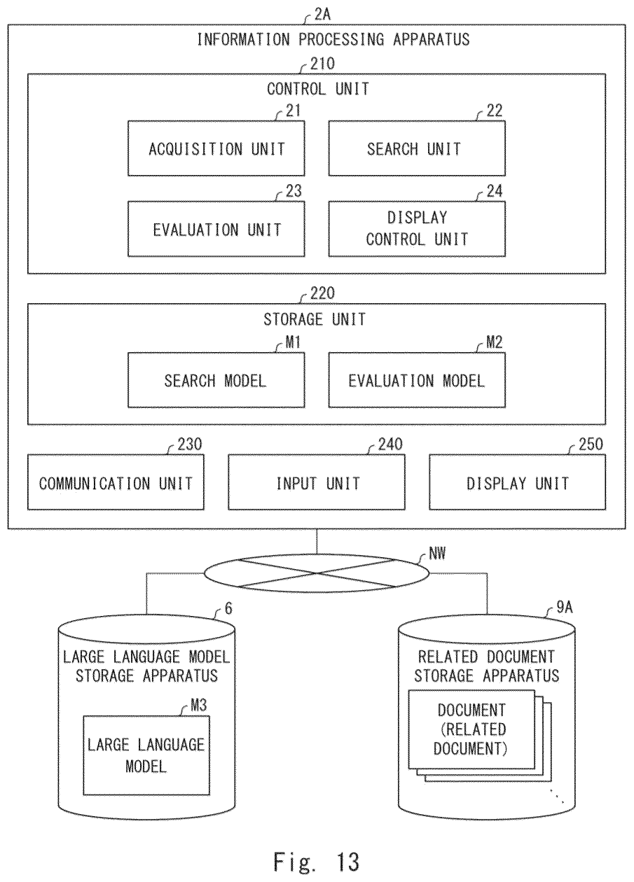

“Output information obtained by inputting the first target description to the search model M1 before training” will be described with reference to FIG. 12. FIG. 12 is a diagram schematically illustrating training data of the search model M1 generated in the present modification. As illustrated in FIG. 12, the training data Ta′ is training data obtained by further including another document description P1′ in the training data Ta including the target claim C1 and the document description P1. For example, the another document description P1′ is obtained as output information by inputting the target claim C1 to the search model M1 before training. The another document description P1′ may be a description in a document different from the document description P1, or may be a different description described in the same document as the document description P1. The another document description P1′ is an example of a third related description.

As a result, in a case where the target claim C1 is input, the search model training unit 18 trains the search model M1 so that the document description P1 is output and the another document description P1′ is not output. For example, the search model training unit 18 may adjust the parameter of the feature amount space used by the search model M1 so that the similarity between the target claim C1 and the document description P1 becomes higher and the similarity between the target claim C1 and the another document description P1′ becomes lower.

### Effects of Information Processing Apparatus 1A

As described above, in the information processing apparatus 1A, the target document includes positive information regarding a difference between the target information and second related information, the document acquisition unit 11 further acquires a second related document in which the second related information is described, the information processing apparatus further including the second specification unit 15 for specifying a second target description indicating a description related to the target information in the target document and a second related description indicating a description related to the second related information in the second related document, which are compared in the positive information, the second summarizing unit 16 for generating second summary information summarizing the positive information, and the second training data generation unit 17 for generating training data as a positive example of one of the search model M1 and the evaluation model M2 and generating training data as a negative example of another by using a part or all of the second target description, the second related description, and the second summary information, and the second training data generation unit 17 generates training data Tb as a negative example of the search model M1 using the second target description and the second related description, and generates training data Tc as a positive example of the evaluation model M2 using the second target description, the second related description, and the second summary information.

Therefore, according to the information processing apparatus 1A, the same information obtained based on the target document can be used as training data serving as a positive example of one of the search model and the evaluation model as training data serving as a negative example of another. Therefore, it is possible to obtain an effect that more high-quality training data can be generated while reducing the cost related to the construction of high-quality training data for training the search model and the evaluation model for evaluating the difference between the desired information and the related information by machine learning. It is possible to obtain an effect that not only the viewpoint of the evaluator but also the viewpoint of the party related to the desired information can be reflected in the search model and the evaluation model.

In the information processing apparatus 1A, the evaluation document includes negative information regarding a difference between the target information and the first related information as the evaluation result, and the first training data generation unit 14 generates the training data Ta as a positive example of the search model M1 using the first target description and the first related description and generates the training data Td as a negative example of the evaluation model M2 using the first target description, the first related description, and the first summary information.

Therefore, according to the information processing apparatus 1A, in addition to the effects obtained by the information processing apparatus 1, it is possible to obtain an effect that the viewpoint of the evaluator who has made a negative evaluation regarding the difference can be reflected in the search model and the evaluation model.

In the information processing apparatus 1A, the first specification unit 12 extracts information indicating a description position in the target document of the first target description and a description position in the first related document of the first related description from the evaluation document by using the large language model M3, and specifies the first target description and the first related description based on a description position indicated by the information extracted.

Therefore, according to the information processing apparatus 1A, it is possible to more reliably specify the first target description and the first related description in addition to the effects obtained by the information processing apparatus 1. In a case where the search model M1 and the evaluation model M2 trained by the information processing apparatus 1A are used, it is possible to obtain an effect that input information in an expression format similar to the expression format of the target information in the target document can be more accurately handled.

In the information processing apparatus 1A, the first training data generation unit 14 further generates, as the third related description as a negative example with respect to the first target description, at least a part of information other than the first related description included in the first related document or output information obtained by inputting the first target description into the search model M1 before training, and further includes the third related description as a negative example in the training data as a positive example of the search model M1.

Therefore, according to the information processing apparatus 1A, in addition to the effects obtained by the information processing apparatus 1, it is possible to obtain an effect that training data for training the search model M1 can be generated related to the case of the search model M1 that requires both the positive example and the negative example for the same input at the time of training.

In the information processing apparatus 1A, the target document is a patent application specification, the evaluation document is a notice of reasons for refusal notified to a patent application indicated by the patent application specification, and the first related document is a cited document described in the notice of reasons for refusal.

Therefore, according to the information processing apparatus 1A, in addition to the effect obtained by the information processing apparatus 1, it is possible to reduce the construction cost of high-quality training data for training the search model M1 and the evaluation model M2 for evaluating whether there is a significant difference between the desired invention and the related technology.

The information processing apparatus 1A further includes the search model training unit 18 for training the search model M1 by machine learning using the training data Ta and Tb generated as a positive example or a negative example of the search model M1, and the evaluation model training unit 19 for training the evaluation model M2 by machine learning using the training data Tc and Td generated as a positive example or a negative example of the evaluation model M2.

Therefore, according to the information processing apparatus 1A, in addition to the effects obtained by the information processing apparatus 1, the search model M1 and the evaluation model M2 for evaluating the difference between the desired information and the related information can be accurately trained using high-quality training data generated at a lower cost. As a result, it is possible to obtain an effect that the generation cost of the search model M1 and the evaluation model M2 can be reduced.

### Fourth Exemplary Example Embodiment

A fourth exemplary example embodiment that is an example of the example embodiments of the present disclosure will be described in detail with reference to the drawings. Components including the same functions as the components described in the above-described exemplary example embodiment are denoted by the same reference signs, and the description thereof will be appropriately omitted. An application range of each technique adopted in the present exemplary example embodiment is not limited to the present exemplary example embodiment. That is, each technique adopted in the present exemplary example embodiment can also be adopted in another exemplary example embodiment included in the present disclosure within a range in which no particular technical problem occurs. Each technique illustrated in each of the drawings referred to for describing the present exemplary example embodiments can be employed in the other exemplary example embodiments included in the present disclosure within the scope in which no particular technical problem occurs.

### Configuration of Information Processing System 20A

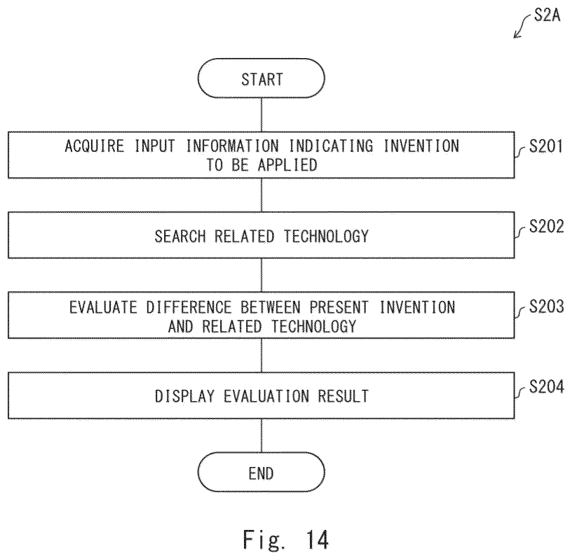

A configuration of an information processing system 20A will be described with reference to FIG. 13. FIG. 13 is a block diagram illustrating the configuration of the information processing system 20A. As illustrated in FIG. 13, the information processing system 20A includes an information processing apparatus 2A, a large language model storage apparatus 6, and a related document storage apparatus 9A. The information processing apparatus 2A is communicably connected to each of the large language model storage apparatus 6 and the related document storage apparatus 9A via a network NW. Some or all of these apparatuses may be connected as peripheral devices instead of being connected to the information processing apparatus 2A via the network NW, or may be incorporated in the information processing apparatus 2. A specific example of the network NW is as described above.

### Large Language Model Storage Apparatus 6

The large language model storage apparatus 6 will be described similarly to the large language model storage apparatus 6 connected to the information processing apparatus 1A.

### Related Document Storage Apparatus 9A

The related document storage apparatus 9 stores documents. The stored documents preferably include, but are not limited to, related documents stored in the related document storage apparatus 9. The stored documents may include documents that are not stored in the related document storage apparatus 9, but are not limited thereto. In other words, the related document storage apparatus 9A desirably stores at least related documents used for training the search model M1 and the evaluation model M2, and may further store documents not used for training. The stored document may be divided into constituent units (for example, paragraphs, pages, and the like).

### Information Processing Apparatus 2A

The information processing apparatus 2A includes a control unit 210, a storage unit 220, a communication unit 230, an input unit 240, and a display unit 250. These units are configured as follows as an example.

### Input Unit 240 and Display Unit 250

The input unit 240 includes an input apparatus such as a keyboard, a mouse, a microphone, or a touchpad. The display unit 250 includes a display apparatus of a display. The input unit 240 and the display unit 250 may include an input/output apparatus integrally formed as a touch panel or the like. At least a part of one or both of the input unit 240 and the display unit 250 may be connected to the information processing apparatus 2A as a peripheral device instead of being built in the information processing apparatus 2A, or may be built in or connected to a terminal (not illustrated) communicably connected to the information processing apparatus 2A.

### Communication Unit 230

The communication unit 230 is connected to the network NW and communicates with an apparatus outside the information processing apparatus 2A. The communication unit 230 transmits data supplied from the control unit 210 to an external apparatus, and supplies data received from the external apparatus to the control unit 210. As an example, the communication unit 230 communicates with the large language model storage apparatus 6. The data transmitted by the communication unit 230 to the large language model storage apparatus 6 may include input information to the large language model M3. The data received by the communication unit 230 from the large language model storage apparatus 6 may include output information from the large language model M3. As an example, the communication unit 230 communicates with the related document storage apparatus 9A. The data transmitted from the communication unit 230 to the related document storage apparatus 9A may include a document request. The data received by the communication unit 230 from the related document storage apparatus 9A may include the requested document.

### Storage Unit 220

The storage unit 220 stores various data referred to by the control unit 210 and various data generated by the control unit 210. At least a part of the storage unit 220 may be connected to the information processing apparatus 2A as a peripheral device instead of being built in the information processing apparatus 2A, or may be included in an apparatus (not illustrated) communicably connected to the information processing apparatus 2A via the network NW. For example, the storage unit 220 stores the search model M1 and the evaluation model M2. The search model M1 and the evaluation model M2 are models trained by the information processing apparatus 1A.

### Control Unit 210

The control unit 210 integrally controls each unit of the information processing apparatus 2A. For example, the control unit 210 includes a display control unit 24 in addition to the acquisition unit 21, the search unit 22, and the evaluation unit 23 included in the information processing apparatus 2. The display control unit 24 is an example of a configuration that implements a display control means.

The acquisition unit 21, the search unit 22, and the evaluation unit 23 are configured as follows in addition to being configured similarly to the information processing apparatus 2. The acquisition unit 21 acquires, as an example of input information indicating the evaluation target information, input information indicating an invention to be applied for. The search unit 22 uses the search model M1 to search the related technology related to the invention indicated by the input information. The evaluation unit 23 uses the evaluation model M2 to evaluate the difference between the invention indicated by the input information and the related technology.

The display control unit 24 displays the search result by the search unit 22 and the evaluation result by the evaluation unit 23 on the display unit 250.

### Flow of Information Processing Method S2a

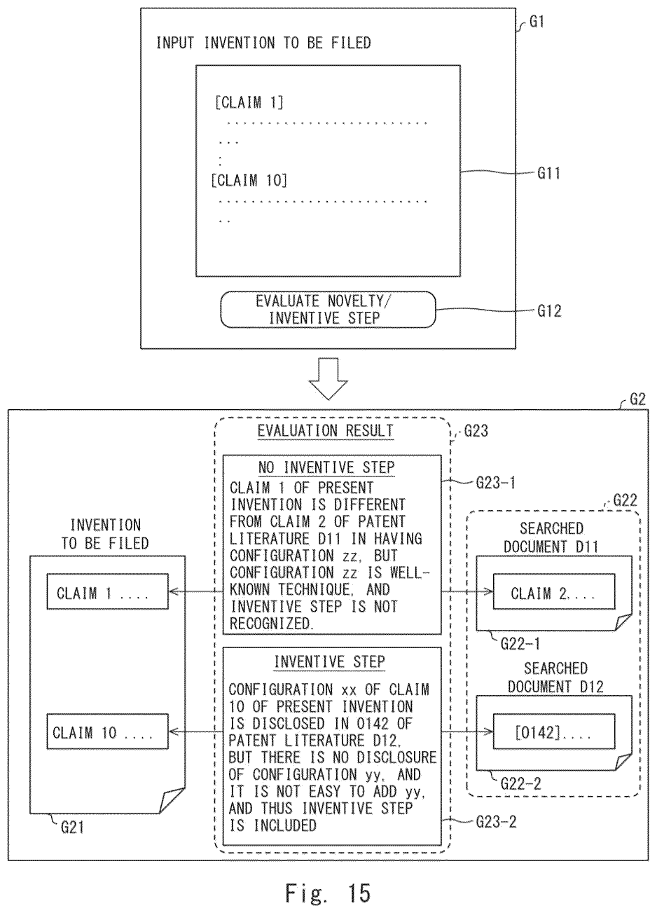

The information processing apparatus 2A configured as described above executes an information processing method S2A. FIG. 14 is a flowchart illustrating a flow of the information processing method S2A. As illustrated in FIG. 14, the information processing method S2A includes steps S201 to S204.

Step S201 is an example of the acquisition processing. In step S201, the acquisition unit 21 acquires input information indicating an invention to be filed. The input information may be described in claim form, for example.

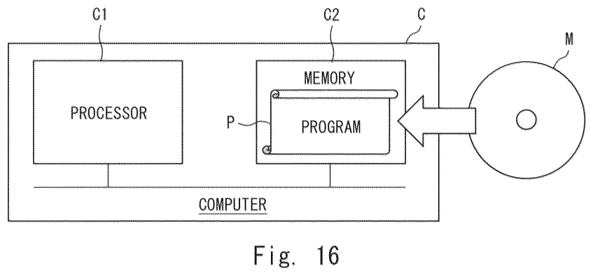

FIG. 15 is a diagram schematically illustrating an example of a screen displayed on the display unit 250 of the information processing apparatus 2A. Screen example G1 illustrated in FIG. 15 is an example of a screen displayed in step S201. The screen example G1 includes a text field G11 and an operation object G12. In the text field G11, a description expressing an invention to be filed in a claim format, for example, is input by the user using the input unit 240. The operation object G12 receives a user's instruction to evaluate novelty and inventive step with respect to the input information input in the text field G11.

As illustrated in FIG. 15, in a case where the input information includes a plurality of descriptions regarding the invention (for example, claims 1, 10, and the like), the processing in the following steps S202 to S203 is executed for each of the plurality of descriptions.

Step S202 is an example of the search processing. In step S202, the search unit 22 inputs the description regarding the invention included in the input information to the search model M1. As a result, output information including the constituent unit related to the invention among the constituent units of the document described in the related document storage apparatus 9A is output from the search model M1. The constituent unit included in the output information is document description indicating a related technology related to the invention. The output information includes the description position of the document description (paragraph numbers, page numbers, line numbers, or the like).

Step S203 is an example of the evaluation processing. In step S203, the evaluation unit 23 inputs the description related to the invention included in the input information and the document description indicating the related technology to the evaluation model M2. As a result, an evaluation result is output from the evaluation model M2. The evaluation result includes negative information or positive information regarding the difference between the invention and the related technology indicated by the document description.

In step S204, the display control unit 24 displays the search result by the search unit 22 and the evaluation result by the evaluation unit 23 on the display unit 250. Screen example G2 illustrated in FIG. 15 is an example of a screen displayed in step S204. The screen example G2 includes input information G21, a search result G22, and an evaluation result G23. The input information G21 is information input to the text field G11 in the screen example G1, and includes a plurality of descriptions (for example, claim 1, claim 10, and the like) indicating an invention to be filed.

The search result G22 indicates a search result obtained by inputting the input information G21 to the search model M1, and includes search results G22-1 and G22-2. The search result G22-1 indicates that claim 2 of document D11 has been searched as the related technology related to the description of claim 1 included in the input information G21. The search result G22-2 indicates that paragraph 0142 of document D12 has been searched as the related technology related to the description of claim 10 included in the input information G21.

The evaluation result G23 indicates an evaluation result obtained by inputting the input information G21 and the search result G22 to the evaluation model M2, and includes evaluation results G23-1 and G23-2. The evaluation result G23-1 indicates that there is no significant difference between the invention indicated by claim 1 included in the input information G21 and the related technology indicated by claim 2 of document D11. The evaluation result G23-1 includes information indicating the evaluation of “no inventive step” and the description thereof. The evaluation result G23-2 indicates that there is a significant difference between the invention indicated by claim 10 included in the input information G21 and the related technology indicated in paragraph 0142 of document D12. The evaluation result G23-2 includes information indicating the evaluation of “inventive step” and the description thereof.

### Effects of Information Processing Apparatus 2A

As described above, the information processing apparatus 1A further includes the display control unit 24 that displays the search result by the search unit 22 and the evaluation result by the evaluation unit 23 on the display unit 250.

Therefore, according to the information processing apparatus 2A, in addition to the effect obtained by the information processing apparatus 2, it is possible to obtain an effect that the user can know the evaluation result reflecting at least the viewpoint of the evaluator regarding the difference between the desired technology (for example, the invention to be filed) and the related technology searched reflecting at least the viewpoint of the evaluator (for example, the examiner).

### Implementation Example by Software

Some or all of the functions of the information processing apparatuses 1, 1A, 2, and 2A (hereinafter, also referred to as “each of the above apparatuses”) may be implemented by hardware such as an integrated circuit (IC chip) or may be implemented by software.

In the latter case, each of the above apparatuses is implemented by, for example, a computer that executes commands of a program, that is software for implementing each function. An example of such a computer (hereinafter, referred to as a computer C) is illustrated in FIG. 16. FIG. 16 is a block diagram illustrating a hardware configuration of a computer C functioning as each of the above apparatuses.

The computer C includes at least one processor C1 and at least one memory C2. A program P for causing the computer C to operate as each of the above apparatuses is recorded in the memory C2. In the computer C, by the processor C1 reading the program P from the memory C2 and executing the program P, each function of each of the above apparatuses is achieved.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof can be used. As the memory C2, for example, a flash memory, a hard disk drive (HDD), a solid state drive (SSD), or a combination thereof can be used.

The computer C may further include a random access memory (RAM) for loading the program P at the time of execution and temporarily storing various data. The computer C may further include a communication interface for transmitting and receiving data to and from another apparatus. The computer C may further include an input/output interface for connecting input/output devices such as a keyboard, a mouse, a display, and a printer.

The program P can be recorded on a non-transitory tangible recording medium M readable by the computer C. As such a recording medium M, for example, a tape, a disk, a card, a semiconductor memory, a programmable logic circuit, or the like can be used. The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

The program P can be stored and provided to a computer using any type of non-transitory computer readable media M. Non-transitory computer readable media M include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM, etc.). The program P may be provided to the computer C using any type of transitory computer readable media. Examples of transitory computer readable media include electric signals, optical signals, and electromagnetic waves. Transitory computer readable media can provide the program P to the computer C via a wired communication line (e.g. electric wires, and optical fibers) or a wireless communication line.

Each of the above functions of each of the above apparatuses may be achieved by a single processor provided in a single computer, may be achieved in cooperation with a plurality of processors provided in a single computer, or may be achieved in cooperation with a plurality of processors provided in a plurality of computers. The program for causing each of the above apparatuses to achieve each of the above functions may be stored in a single memory provided in a single computer, may be stored in a distributed manner in a plurality of memories provided in a single computer, or may be stored in a distributed manner in a plurality of memories provided in a plurality of computers.

### SUPPLEMENTARY MATTERS

The present disclosure includes the techniques described in the following Supplementary Notes. However, the present disclosure is not limited to the techniques described in the following Supplementary Notes, and various modifications can be made within the scope described in the claims.

### Supplementary Note 1

An information processing apparatus including:
a document acquisition means for acquiring an evaluation document in which an evaluation result regarding a difference between target information and first related information is described, a target document in which the target information is described, and a first related document in which the first related information is described;
a first specification means for specifying a first target description indicating a description regarding the target information in the target document and a first related description indicating a description regarding the first related information in the first related document, which are compared in the evaluation result;
a first summarizing means for generating first summary information summarizing the evaluation results; and
a first training data generation means for generating training data as a positive example of one of a search model for searching for related information related to evaluation target information indicated by input information and an evaluation model for evaluating a difference between the evaluation target information and the related information by using a part or all of the first target description, the first related description, and the first summary information, and generating training data as a negative example of another.

### Supplementary Note 2

The information processing apparatus according to Supplementary Note 1, wherein
the target document includes positive information regarding a difference between the target information and second related information,
the document acquisition means further acquires a second related document in which the second related information is described,
the information processing apparatus further including:
a second specification means for specifying a second target description indicating a description related to the target information in the target document and a second related description indicating a description related to the second related information in the second related document, which are compared in the positive information;
a second summarizing means for generating second summary information summarizing the positive information; and
a second training data generation means for generating training data as a positive example of one of the search model and the evaluation model and generating training data as a negative example of another by using a part or all of the second target description, the second related description, and the second summary information, and
the second training data generation means:
generates training data as a negative example of the search model using the second target description and the second related description; and
generates training data as a positive example of the evaluation model using the second target description, the second related description, and the second summary information.

### Supplementary Note 3

The information processing apparatus according to Supplementary Note 1 or 2, wherein
the evaluation document includes negative information regarding a difference between the target information and the first related information as the evaluation result, and
the first training data generation means:
generates training data as a positive example of the search model using the first target description and the first related description; and
generates training data as a negative example of the evaluation model using the first target description, the first related description, and the first summary information.

### Supplementary Note 4

The information processing apparatus according to any one of Supplementary Notes 1 to 3, wherein
the first specification means:
extracts information indicating a description position in the target document of the first target description and a description position in the first related document of the first related description from the evaluation document by using a large language model; and specifies the first target description and the first related description based on a description position indicated by the information extracted.

### Supplementary Note 5

The information processing apparatus according to Supplementary Note 3, wherein
the first training data generation means:
further generates at least a part of information different from the first related description in information included in the first related document, or
output information obtained by inputting the first target description to the search model before training,
as a third related description as a negative example with respect to the first target description; and
further includes the third related description as a negative example in the training data as a positive example of the search model.

### Supplementary Note 6

The information processing apparatus according to any one of Supplementary Notes 1 to 5, wherein
the target document is a patent application specification,
the evaluation document is a notice of reasons for refusal notified to a patent application indicated by the patent application specification, and
the first related document is a cited document described in the notice of reasons for refusal.

### Supplementary Note 7

The information processing apparatus according to any one of Supplementary Notes 1 to 6, further including:
a search model training means for training the search model by machine learning using the training data generated as a positive example or a negative example of the search model; and
an evaluation model training means for training the evaluation model by machine learning using the training data generated as a positive example or a negative example of the evaluation model.

### Supplementary Note 8

An information processing apparatus using the search model and the evaluation model trained by machine learning using training data generated by the information processing apparatus according to any one of Supplementary Notes 1 to 7,
the information processing apparatus further including:
an acquisition means for acquiring input information indicating evaluation target information;
a search means for searching for related information related to the evaluation target information using the search model; and
an evaluation means for evaluating a difference between the evaluation target information and the related information by using the evaluation model.

### Supplementary Note 9

The information processing apparatus according to Supplementary Note 8, further including a display control means for displaying a search result by the search means and an evaluation result by the evaluation means on a display unit.

### Supplementary Note 10

An information processing method including:
document acquisition processing of acquiring, by at least one processor, an evaluation document in which an evaluation result regarding a difference between target information and first related information is described, a target document in which the target information is described, and a first related document in which the first related information is described;
first specification processing of specifying, by the at least one processor, a first target description indicating a description regarding the target information in the target document and a first related description indicating a description regarding the first related information in the first related document, which are compared in the evaluation result;
first summarizing processing of generating, by the at least one processor, first summary information summarizing the evaluation results; and
first training data generation processing of generating, by the at least one processor, training data as a positive example of one of a search model for searching for related information related to evaluation target information indicated by input information and an evaluation model for evaluating a difference between the evaluation target information and the related information by using a part or all of the first target description, the first related description, and the first summary information, and generating training data as a negative example of another.

### Supplementary Note 11

A program for causing a computer to function as an information processing apparatus,
the program causing the computer to function as:
a document acquisition means for acquiring an evaluation document in which an evaluation result regarding a difference between target information and first related information is described, a target document in which the target information is described, and a first related document in which the first related information is described;
a first specification means for specifying a first target description indicating a description regarding the target information in the target document and a first related description indicating a description regarding the first related information in the first related document, which are compared in the evaluation result;
a first summarizing means for generating first summary information summarizing the evaluation results; and
a first training data generation means for generating training data as a positive example of one of a search model for searching for related information related to evaluation target information indicated by input information and an evaluation model for evaluating a difference between the evaluation target information and the related information by using a part or all of the first target description, the first related description, and the first summary information, and generating training data as a negative example of another.

### Supplementary Note 12

An information processing method using the search model and the evaluation model trained by machine learning using training data generated by the information processing method according to Supplementary Note 10,
the information processing method including:
acquisition processing of acquiring, by at least one processor, input information indicating evaluation target information;
search processing of searching, by the at least one processor, related information related to the evaluation target information by using the search model; and
evaluation processing of evaluating, by the at least one processor, a difference between the evaluation target information and the related information by using the evaluation model.

### Supplementary Note 13

A program for causing a computer to function as an information processing apparatus that uses the search model and the evaluation model trained by machine learning using training data generated by the program according to Supplementary Note 11,
the program causing the computer to function as:
an acquisition means for acquiring input information indicating evaluation target information;
a search means for searching for related information related to the evaluation target information using the search model; and
an evaluation means for evaluating a difference between the evaluation target information and the related information by using the evaluation model.

### Supplementary Note 14

An information processing apparatus including at least one processor, wherein
the at least one processor executes:
document acquisition processing of acquiring an evaluation document in which an evaluation result regarding a difference between target information and first related information is described, a target document in which the target information is described, and a first related document in which the first related information is described;
first specification processing of specifying a first target description indicating a description regarding the target information in the target document and a first related description indicating a description regarding the first related information in the first related document, which are compared in the evaluation result;
first summarizing processing of generating first summary information summarizing the evaluation results; and
first training data generation processing of generating training data as a positive example of one of a search model for searching for related information related to evaluation target information indicated by input information and an evaluation model for evaluating a difference between the evaluation target information and the related information by using a part or all of the first target description, the first related description, and the first summary information, and generating training data as a negative example of another.

The information processing apparatus may further include a memory. The memory may store a program for causing the at least one processor to execute each processing.

1. An information processing apparatus comprising:
at least one memory storing instructions, and
at least one processor configured to execute the instructions to;
acquire an evaluation document in which an evaluation result regarding a difference between target information and first related information is described, a target document in which the target information is described, and a first related document in which the first related information is described;
specify a first target description indicating a description regarding the target information in the target document and a first related description indicating a description regarding the first related information in the first related document, which are compared in the evaluation result;
generate first summary information summarizing the evaluation results; and
generate training data as a positive example of one of a search model for searching for related information related to evaluation target information indicated by input information and an evaluation model for evaluating a difference between the evaluation target information and the related information by using a part or all of the first target description, the first related description, and the first summary information, and generating training data as a negative example of another.

2. The information processing apparatus according to claim 1, wherein
the target document includes positive information regarding a difference between the target information and second related information, and
the at least one processor is further configured to execute the instructions to;
acquire a second related document in which the second related information is described;
specify a second target description indicating a description related to the target information in the target document and a second related description indicating a description related to the second related information in the second related document, which are compared in the positive information;
generate second summary information summarizing the positive information;
generate training data as a positive example of one of the search model and the evaluation model and generating training data as a negative example of another by using a part or all of the second target description, the second related description, and the second summary information;
generate training data as a negative example of the search model using the second target description and the second related description; and
generate training data as a positive example of the evaluation model using the second target description, the second related description, and the second summary information.

3. The information processing apparatus according to claim 1, wherein
the evaluation document includes negative information regarding a difference between the target information and the first related information as the evaluation result, and
the at least one processor is further configured to execute the instructions to;
generate training data as a positive example of the search model using the first target description and the first related description; and
generate training data as a negative example of the evaluation model using the first target description, the first related description, and the first summary information.

4. The information processing apparatus according to claim 1, wherein the at least one processor is further configured to execute the instructions to;
extract information indicating a description position in the target document of the first target description and a description position in the first related document of the first related description from the evaluation document by using a large language model; and
specify the first target description and the first related description based on a description position indicated by the information extracted.

5. The information processing apparatus according to claim 3, wherein the at least one processor is further configured to execute the instructions to;
further generate at least a part of information different from the first related description in information included in the first related document, or
output information obtained by inputting the first target description to the search model before training,
as a third related description as a negative example with respect to the first target description; and
further include the third related description as a negative example in the training data as a positive example of the search model.

6. The information processing apparatus according to claim 1, wherein
the target document is a patent application specification,
the evaluation document is a notice of reasons for refusal notified to a patent application indicated by the patent application specification, and
the first related document is a cited document described in the notice of reasons for refusal.

7. The information processing apparatus according to claim 1, wherein the at least one processor is further configured to execute the instructions to;
train the search model by machine learning using the training data generated as a positive example or a negative example of the search model; and
train the evaluation model by machine learning using the training data generated as a positive example or a negative example of the evaluation model.

8. An information processing apparatus using the search model and the evaluation model trained by machine learning using training data generated by the information processing apparatus according to claim 1, comprising;
at least one memory storing instructions, and
at least one processor configured to execute the instructions to;
acquire input information indicating evaluation target information;
search for related information related to the evaluation target information using the search model; and
evaluate a difference between the evaluation target information and the related information by using the evaluation model.

9. The information processing apparatus according to claim 8, wherein the at least one processor is further configured to execute the instructions to display a search result and an evaluation result on a display unit.

10. An information processing method comprising:
document acquisition processing of acquiring, by at least one processor, an evaluation document in which an evaluation result regarding a difference between target information and first related information is described, a target document in which the target information is described, and a first related document in which the first related information is described;
first specification processing of specifying, by the at least one processor, a first target description indicating a description regarding the target information in the target document and a first related description indicating a description regarding the first related information in the first related document, which are compared in the evaluation result;
first summarizing processing of generating, by the at least one processor, first summary information summarizing the evaluation results; and
first training data generation processing of generating, by the at least one processor, training data as a positive example of one of a search model for searching for related information related to evaluation target information indicated by input information and an evaluation model for evaluating a difference between the evaluation target information and the related information by using a part or all of the first target description, the first related description, and the first summary information, and generating training data as a negative example of another.
